(19) United States
(12) Patent Application Publication
(10) Pub. No.: US 2015/0350288 A1
(43) Pub. Date: Dec. 3, 2015

(54) MEDIA AGNOSTIC DISPLAY FOR WI-FI DISPLAY

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US)

(21) Appl. No.: 14/530,283

(22) Filed: Oct. 31, 2014

Related U.S. Application Data
(60) Provisional application No. 62/004,158, filed on May 28, 2014.

(51) Int. Cl. H04L 29/06

(52) U.S. Cl. CPC H04L 65/608; H04L 65/1083; H04L 69/161

(57) ABSTRACT

In techniques of this disclosure, a source device establishes a connection to a sink device. The source device performs a service discovery using a real time streaming protocol (RTSP) mechanism. In some examples, the service discovery provides media agnostic display attributes of the sink device to the source device and a connection type between the source device and the sink device. The source device encapsulates application data at the source device based at least in part on the connection type. The source device establishes a streaming session between the source device and the sink device. In the streaming session, the source device sends the encapsulated application data to the sink device.

This application claims the benefit of U.S. Provisional Application No. 62/004,158, filed May 28, 2014, the entire content of which is incorporated herein by reference.

### TECHNICAL FIELD

The disclosure relates to transport and playback of media data and, more particularly, control over the transport and playback of media data.

### BACKGROUND

Wireless display (WD) systems include a source device and one or more sink devices. A source device may be a device that is capable of transmitting media content within a wireless local area network. A sink device may be a device that is capable of receiving and rendering media content. The source device and the sink devices may be either mobile devices or wired devices. As mobile devices, for example, the source device and the sink devices may comprise mobile telephones, portable computers with wireless communication cards, personal digital assistants (PDAs), portable media players, digital image capturing devices, such as a camera or camcorder, or other flash memory devices with wireless communication capabilities, including so-called “smart” phones and “smart” pads or tablets, or other types of wireless communication devices. As wired devices, for example, the source device and the sink devices may comprise televisions, desktop computers, monitors, projectors, printers, audio amplifiers, set top boxes, gaming consoles, routers, and digital video disc (DVD) players, and media servers.

A source device may send media data, such as audio video (AV) data, to one or more of the sink devices participating in a particular media share session. The media data may be played back at both a local display of the source device and at each of the displays of the sink devices. More specifically, each of the participating sink devices renders the received media data for presentation on its screen and audio equipment. In some cases, a user of a sink device may apply user inputs to the sink device, such as touch inputs and remote control inputs.

### SUMMARY

In one example, the disclosure is directed to a method of transmitting media data, the method comprising establishing, by a source device, a connection to a sink device, performing, by the source device, a service discovery using a real time streaming protocol (RTSP) mechanism, wherein the service discovery provides media agnostic display attributes of the sink device to the source device and a connection type between the source device and the sink device, encapsulating, by the source device, application data at the source device based at least in part on the connection type and the media agnostic display attributes, establishing, by the source device, a streaming session between the source device and the sink device, and sending, by the source device in the streaming session, the encapsulated application data to the sink device.

In another example, the disclosure is directed to a device for transmitting media data, the device comprising a memory storing application data and one or more processors configured to establish a connection to a sink device, perform a service discovery using a real time streaming protocol (RTSP) mechanism, wherein the service discovery provides media agnostic display attributes of the sink device to the source device and a connection type between the source device and the sink device, encapsulate application data at the source device based at least in part on the connection type and the media agnostic display attributes, establish a streaming session between the source device and the sink device, and send, in the streaming session, the encapsulated application data to the sink device.

In another example, the disclosure is directed to a computer-readable medium comprising instructions stored thereon that when executed in a processor of a source device to establish a connection to a sink device, perform a service discovery using a real time streaming protocol (RTSP) mechanism, wherein the service discovery provides media agnostic display attributes of the sink device to the source device and a connection type between the source device and the sink device, encapsulate application data at the source device based at least in part on the connection type and the media agnostic display attributes, establish a streaming session between the source device and the sink device, and send, in the streaming session, the encapsulated application data to the sink device.

In another example, the disclosure is directed to an apparatus for transmitting media data, the apparatus comprising means for establishing a connection to a sink device, means for performing a service discovery using a real time streaming protocol (RTSP) mechanism, wherein the service discovery provides media agnostic display attributes of the sink device to the source device and a connection type between the source device and the sink device, means for encapsulating application data at the source device based at least in part on the connection type and the media agnostic display attributes, means for establishing a streaming session between the source device and the sink device, and means for sending, in the streaming session, the encapsulated application data to the sink device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a wireless communication system including a source device and a sink device.

FIG. 2 is a block diagram illustrating an example of a source device that may implement techniques of this disclosure.

FIG. 3 is a block diagram illustrating an example of a sink device that may implement techniques of this disclosure.

FIG. 4 shows a block diagram illustrating a transmitter system and a receiver system that may implement techniques of this disclosure.

FIG. 5 is block diagram illustrating functional blocks in wireless display data and control panes, according to one or more techniques of this disclosure.

FIG. 6 is a block diagram illustrating a media agnostic display architecture with a media agnostic display service, according to one or more techniques of this disclosure.

FIG. 7 is a block diagram illustrating a media agnostic display architecture without a media agnostic display service, according to one or more techniques of this disclosure.

FIG. 8 is a flow diagram illustrating one or more techniques of this disclosure for a media agnostic display architecture on a source device, according to one or more techniques of this disclosure.

FIG. 9 is a flow diagram illustrating one or more techniques of this disclosure for a media agnostic display architecture with streaming adaptation capabilities, according to one or more techniques of this disclosure.

### DETAILED DESCRIPTION

This disclosure relates to a media agnostic display (MAD), which is a display protocol, which is media agnostic. It defines the procedure to transfer audio, video, graphics, and user input controls irrespective of the connectivity layer (L2/L1). MAD includes the data plane and control plane.

In some examples, a media agnostic display service (MAD service) may be included and may interact with the MAD. The MAD service defines procedures for pre-connection device/service discovery, connection setup, maintenance, and teardown. MAD Service may not media agnostic and is optional.

Multiple screencasting, mirroring, and streaming protocols exist today for different connectivity types. For example, the Universal Serial Bus Implementers Forum (USB-IF) defines AV class drivers for mirroring over a Universal Serial Bus (USB) connection. Wi-Fi Alliance defines Miracast for mirroring over Wi-Fi. Not all have the capability to support graphics and user input control transmission and operation.

MAD is agnostic to connectivity (USB/Wi-Fi Serial Bus (WSB)/Wi-Fi, etc.) and enables mirroring and streaming of audio, video, graphics content, and user input controls from MAD Source to MAD Sink. For example, the MAD may be used for Wi-Fi Alliance Wi-Fi CERTIFIED Miracast™, USB connections, Ethernet connections, Bluetooth connections, or any other type of connection, wired or wireless, that allows for the transfer of data.

MAD Service is optionally made aware by the MAD about (i) display device information, (ii) display audio formats, (iii) display video formats, (iii) display 3D video formats, (iv) content protection, (v) graphics entity engine, (vi) vendor specific information. This information is necessary for pre-connection device/service discovery and connection setup.

MAD controls the attributes related to (i) display device information, (ii) display audio formats, (iii) display video formats, (iii) display 3D video formats, (iv) content protection, (v) graphics entity engine, (vi) vendor specific information through Session control mechanisms.

MAD further has the benefit of allowing multiple streams. Multiple windows can be rendered on the Sink and MAD can have a data stream associated with each window.

Even further, MAD has the benefit of allowing adaptation for any of the streams being transmitted from the source to the sink, meaning that the quality can be improved for any of the streams being transmitted from the source to the sink. Based on the wireless channel quality feedback the MAD adapts the data streams for (i) Resolution/Refresh rate, (ii) Codec level/Codec profile, (iii) enable/disable a particular data stream, (iv) enable/disable data stream over TCP, and (v) enable/disable data stream over UDP. This is important when bandwidth changes significantly (10× times for e.g., a session transfer between 802.11ad and 802.11ac).

In the techniques of this disclosure, a source device establishes a connection to a sink device. The source device performs a service discovery using a real time streaming protocol (RTSP) mechanism. In some examples, the service discovery provides media agnostic display attributes of the sink device to the source device and a connection type between the source device and the sink device. The source device encapsulates application data at the source device based at least in part on the connection type. The source device establishes a streaming session between the source device and the sink device. In the streaming session, the source device sends the encapsulated application data to the sink device.

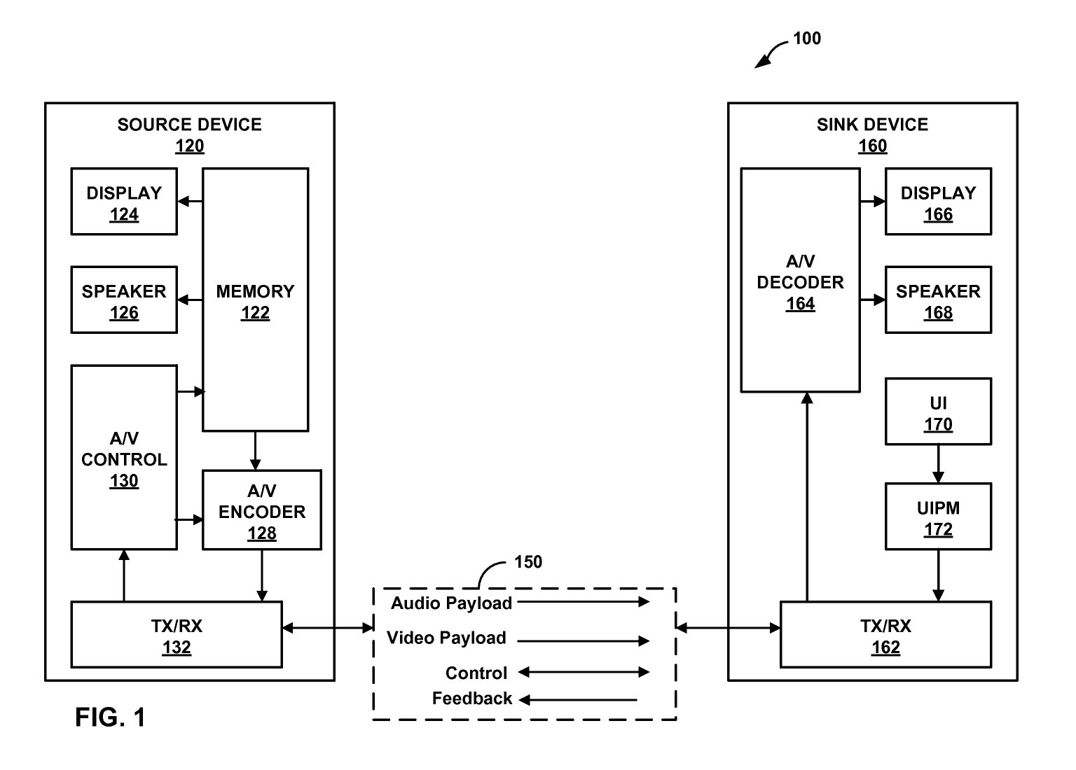

FIG. 1 is a block diagram illustrating an example of a Wireless Display (WD) system 100 including a source device 120 and a sink device 160 capable of supporting the adjustment of transmission of media data based on a performance information message. As shown in FIG. 1, WD system 100 includes source device 120 that communicates with sink device 160 via communication channel 150.

Source device 120 may include a memory 122, display 124, speaker 126, audio and/or video (AN) encoder 128, audio and/or video (A/V) control module 130, and transmitter/receiver (TX/RX) unit 132. Sink device 160 may include transmitter/receiver unit 162, audio and/or video (A/V) decoder 164, display 166, speaker 168, user input (UI) device 170, and user input processing module (UIPM) 172. The illustrated components constitute merely one example configuration for WD system 100. Other configurations may include fewer components than those illustrated or may include additional components than those illustrated.

In the example of FIG. 1, source device 120 can display the video portion of A/V data on display 124 and can output the audio portion of A/V data using speaker 126. A/V data may be stored locally on memory 122, accessed from an external storage medium such as a file server, hard drive, external memory, Blu-ray disc, DVD, or other physical storage medium, or may be streamed to source device 120 via a network connection such as the internet. In some instances A/V data may be captured in real-time via a camera and microphone of source device 120. A/V data may include multimedia content such as movies, television shows, or music, but may also include real-time content generated by source device 120. Such real-time content may for example be produced by applications running on source device 120, or video data captured, e.g., as part of a video telephony session. Such real-time content may in some instances include a video frame of user input options available for a user to select. In some instances, A/V data may include video frames that are a combination of different types of content, such as a video frame of a movie or television (TV) program that has user input options overlaid on the frame of video.

In addition to rendering A/V data locally via display 124 and speaker 126, A/V encoder 128 of source device 120 can encode A/V data and transmitter/receiver unit 132 can transmit the encoded data over communication channel 150 to sink device 160. Transmitter/receiver unit 162 of sink device 160 receives the encoded data, and A/V decoder 164 may decode the encoded data and output the decoded data for presentation on display 166 and speaker 168. In this manner, the audio and video data being rendered by display 124 and speaker 126 can be simultaneously rendered by display 166 and speaker 168. The audio data and video data may be arranged in frames, and the audio frames may be time-synchronized with the video frames when rendered.

A/V encoder 128 and A/V decoder 164 may implement any number of audio and video compression standards, such as the ITU-T H.264 standard, alternatively referred to as MPEG-4, Part 10, Advanced Video Coding (AVC), or the newly emerging high efficiency video coding (HEVC) standard. Many other types of proprietary or standardized compression techniques may also be used. Generally speaking, A/V decoder 164 is configured to perform the reciprocal coding operations of A/V encoder 128. Although not shown in FIG. 1, in some aspects, A/V encoder 128 and A/V decoder 164 may each be integrated with an audio encoder and decoder, and may include appropriate multiplexer-demultiplexer (MUX-DEMUX) units, or other hardware and software, to handle encoding of both audio and video in a common data stream or separate data streams.

As will be described in more detail below, A/V encoder 128 may also perform other encoding functions in addition to implementing a video compression standard as described above. For example, A/V encoder 128 may add various types of metadata to A/V data prior to A/V data being transmitted to sink device 160. In some instances, A/V data may be stored on or received at source device 120 in an encoded form and thus not require further compression by A/V encoder 128.

Although, FIG. 1 shows communication channel 150 carrying audio payload data and video payload data separately, it is to be understood that in some instances video payload data and audio payload data may be part of a common data stream. If applicable, MUX-DEMUX units may conform to the ITU H.223 multiplexer protocol, or other protocols such as the user datagram protocol (UDP). A/V encoder 128 and A/V decoder 164 each may be implemented as one or more microprocessors, digital signal processors (DSPs), application specific integrated circuits (ASICs), field programmable gate arrays (FPGAs), discrete logic, software, hardware, firmware or any combinations thereof. Each of A/V encoder 128 and A/V decoder 164 may be included in one or more encoders or decoders, either of which may be integrated as part of a combined encoder/decoder (CODEC). Thus, each of source device 120 and sink device 160 may comprise specialized machines configured to execute one or more of the techniques of this disclosure.

Display 124 and display 168 may comprise any of a variety of video output devices such as a cathode ray tube (CRT), a liquid crystal display (LCD), a plasma display, a light emitting diode (LED) display, an organic light emitting diode (OLED) display, or another type of display device. In these or other examples, display 124 and 168 may each be emissive displays or transmissive displays. Display 124 and display 166 may also be touch displays such that they are simultaneously both input devices and display devices. Such touch displays may be capacitive, resistive, or other type of touch panel that allows a user to provide user input to the respective device.

Speaker 126 and speaker 168 may comprise any of a variety of audio output devices such as headphones, a single-speaker system, a multi-speaker system, or a surround sound system. Additionally, although display 124 and speaker 126 are shown as part of source device 120 and display 166 and speaker 168 are shown as part of sink device 160, source device 120 and sink device 160 may in fact be a system of devices. As one example, display 166 may be a television, speaker 168 may be a surround sound system, and A/V decoder 164 may be part of an external box connected, either wired or wirelessly, to display 166 and speaker 168. In other instances, sink device 160 may be a single device, such as a tablet computer or smartphone. In still other cases, source device 120 and sink device 160 are similar devices, e.g., both being smartphones, tablet computers, or the like. In this case, one device may operate as the source and the other may operate as the sink. These roles may be reversed in subsequent communication sessions. In still other cases, the source device 120 may comprise a mobile device, such as a smartphone, laptop or tablet computer, and the sink device 160 may comprise a more stationary device (e.g., with an AC power cord), in which case the source device 120 may deliver audio and video data for presentation to a one or more viewers via the sink device 160.

Transmitter/receiver unit 132 and transmitter/receiver unit 162 may each include various mixers, filters, amplifiers and other components designed for signal modulation, as well as one or more antennas and other components designed for transmitting and receiving data. Communication channel 150 generally represents any suitable communication medium, or collection of different communication media, for transmitting audio/video data, control data and feedback between the source device 120 and the sink device 160. Communication channel 150 is usually a relatively short-range communication channel, and may implement a physical channel structure similar to Wi-Fi, Bluetooth, or the like, such as implementing defined 2.4, GHz, 3.6 GHz, 5 GHz, 60 GHz or Ultrawideband (UWB) frequency band structures. However, communication channel 150 is not necessarily limited in this respect, and may comprise any wireless or wired communication medium, such as a radio frequency (RF) spectrum or one or more physical transmission lines, or any combination of wireless and wired media. In other examples, communication channel 150 may even form part of a packet-based network, such as a wired or wireless local area network, a wide-area network, or a global network such as the Internet. Additionally, communication channel 150 may be used by source device 120 and sink device 160 to create a peer-to-peer link.

Source device 120 and sink device 160 may establish a communication session according to a capability negotiation using, for example, Real-Time Streaming Protocol (RTSP) control messages. In one example, a request to establish a communication session may be sent by the source device 120 to the sink device 160. Once the media share session is established, source device 120 transmits media data, e.g., audio video (AV) data, to the participating sink device 160 using the Real-time Transport protocol (RTP). Sink device 160 renders the received media data on its display and audio equipment (not shown in FIG. 1).

Source device 120 and sink device 160 may then communicate over communication channel 150 using a communications protocol such as a standard from the IEEE 802.11 family of standards. In one example communication channel 150 may be a network communication channel. In this example, a communication service provider may centrally operate and administer one or more the network using a base station as a network hub. Source device 120 and sink device 160 may, for example, communicate according to the Wi-Fi Direct or Wi-Fi Display (WFD) standards, such that source device 120 and sink device 160 communicate directly with one another without the use of an intermediary such as wireless access points or so called hotspots. Source device 120 and sink device 160 may also establish a tunneled direct link setup (TDLS) to avoid or reduce network congestion. WFD and TDLS are intended to setup relatively short-distance communication sessions. Relatively short distance in this context may refer to, for example, less than approximately 70 meters, although in a noisy or obstructed environment the distance between devices may be even shorter, such as less than approximately 35 meters, or less than approximately 20 meters.

The techniques of this disclosure may at times be described with respect to WFD, but it is contemplated that aspects of these techniques may also be compatible with other communication protocols. By way of example and not limitation, the wireless communication between source device 120 and sink device may utilize orthogonal frequency division multiplexing (OFDM) techniques. A wide variety of other wireless communication techniques may also be used, including but not limited to time division multi access (TDMA), frequency division multi access (FDMA), code division multi access (CDMA), or any combination of OFDM, FDMA, TDMA and/or CDMA.

In addition to decoding and rendering data received from source device 120, sink device 160 can also receive user inputs from user input device 170. User input device 170 may, for example, be a keyboard, mouse, trackball or track pad, touch screen, voice command recognition module, or any other such user input device. UIPM 172 formats user input commands received by user input device 170 into a data packet structure that source device 120 is capable of processing. Such data packets are transmitted by transmitter/receiver 162 to source device 120 over communication channel 150. Transmitter/receiver unit 132 receives the data packets, and A/V control module 130 parses the data packets to interpret the user input command that was received by user input device 170. Based on the command received in the data packet, A/V control module 130 may change the content being encoded and transmitted. In this manner, a user of sink device 160 can control the audio payload data and video payload data being transmitted by source device 120 remotely and without directly interacting with source device 120.

Additionally, users of sink device 160 may be able to launch and control applications on source device 120. For example, a user of sink device 160 may able to launch a photo editing application stored on source device 120 and use the application to edit a photo that is stored locally on source device 120. Sink device 160 may present a user with a user experience that looks and feels like the photo is being edited locally on sink device 160 while in fact the photo is being edited on source device 120. Using such a configuration, a user may be able to leverage the capabilities of one device for use with several devices. For example, source device 120 may comprise a smartphone with a large amount of memory and high-end processing capabilities. When watching a movie, however, the user may wish to watch the movie on a device with a bigger display screen, in which case sink device 160 may be a tablet computer or even larger display device or television. When wanting to send or respond to email, the user may wish to use a device with a physical keyboard, in which case sink device 160 may be a laptop. In both instances, the bulk of the processing may still be performed by source device 120 even though the user is interacting with sink device 160. The source device 120 and the sink device 160 may facilitate two way interactions by transmitting control data, such as, data used to negotiate and/or identify the capabilities of the devices in any given session over communications channel 150.

In some configurations, A/V control module 130 may comprise an operating system process being executed by the operating system of source device 120. In other configurations, however, A/V control module 130 may comprise a software process of an application running on source device 120. In such a configuration, the user input command may be interpreted by the software process, such that a user of sink device 160 is interacting directly with the application running on source device 120, as opposed to the operating system running on source device 120. By interacting directly with an application as opposed to an operating system, a user of sink device 160 may have access to a library of commands that are not native to the operating system of source device 120. Additionally, interacting directly with an application may enable commands to be more easily transmitted and processed by devices running on different platforms.

User inputs applied at sink device 160 may be sent back to source device 120 over communication channel 150. In one example, a reverse channel architecture, also referred to as a user interface back channel (UIBC) may be implemented to enable sink device 160 to transmit the user inputs applied at sink device 160 to source device 120. The reverse channel architecture may include upper layer messages for transporting user inputs, and lower layer frames for negotiating user interface capabilities at sink device 160 and source device 120. The UIBC may reside over the Internet Protocol (IP) transport layer between sink device 160 and source device 120. In this manner, the UIBC may be above the transport layer in the Open System Interconnection (OSI) communication model. To promote reliable transmission and in sequence delivery of data packets containing user input data, UIBC may be configured to run on top of other packet-based communication protocols such as the transmission control protocol/internet protocol (TCP/IP) or the user datagram protocol (UDP). UDP and TCP may operate in parallel in the OSI layer architecture. TCP/IP may enable sink device 160 and source device 120 to implement retransmission techniques in the event of packet loss.

The UIBC may be designed to transport various types of user input data, including cross-platform user input data. For example, source device 120 may run the iOS® operating system, while sink device 160 runs another operating system such as Android® or Windows®. Regardless of platform, UIPM 172 may encapsulate received user input in a form understandable to A/V control module 130. A number of different types of user input formats may be supported by the UIBC so as to allow many different types of source and sink devices to exploit the protocol regardless of whether the source and sink devices operate on different platforms. Generic input formats that are defined and platform specific input formats may both be supported, thus providing flexibility in the manner in which user input can be communicated between source device 120 and sink device 160 by the UIBC.

According to techniques of this disclosure, a source device (e.g., source device 120) may establish a connection to a sink device (e.g., sink device 160) via the connection type. The source device may perform a service discovery using a real time streaming protocol (RTSP) mechanism. In some examples, the service discovery may provide media agnostic display attributes of the sink device to the source device and a connection type between the source device and the sink device. In some examples, the media agnostic display attributes may include one or more of display device information, display audio formats, display video formats, display three-dimensional video formats, content protection, graphics entity engine, and vendor specific information. The source device may encapsulate application data at the source device based at least in part on the connection type. The source device may establish a streaming session between the source device and the sink device. In the streaming session, the source device may send the encapsulated application data to the sink device.

In some examples, the source device may mirrors its display at a display of the sink device based at least in part on the encapsulated application data. The source device may enable an interaction to control one or more streaming attributes of the streaming session from the source device via a user interface back channel. In some examples, the one or more streaming attributes the streaming attributes may include one or more a resolution rate, a refresh rate, a codec level, an enabling of a particular data stream, a disabling of a particular data stream, an enabling of a data stream over TCP, a disabling of a data stream over TCP, an enabling of a data stream over UDP, and a disabling of a data stream over UDP. Responsive to the streaming attributes indicating a poor connection, the source device may adapt the one or more streaming attributes of the streaming session.

As discussed in further detail below, techniques of this disclosure may be implemented as software on both a source device and a sink device as a software-defined protocol. In other examples, techniques of this disclosure may be implemented as hardware in both a source device and a sink device that is configured to perform techniques of this disclosure. Rather than streaming data between two devices via a protocol that is specific to a physical link or a connection type, techniques of this disclosure may allow devices to stream data between one another agnostic to the type of physical link. This may allow greater connectivity amongst a greater variety of devices rather than current devices which may only be configured for streaming over Wi-Fi networks, USB connections, or Bluetooth connections alone.

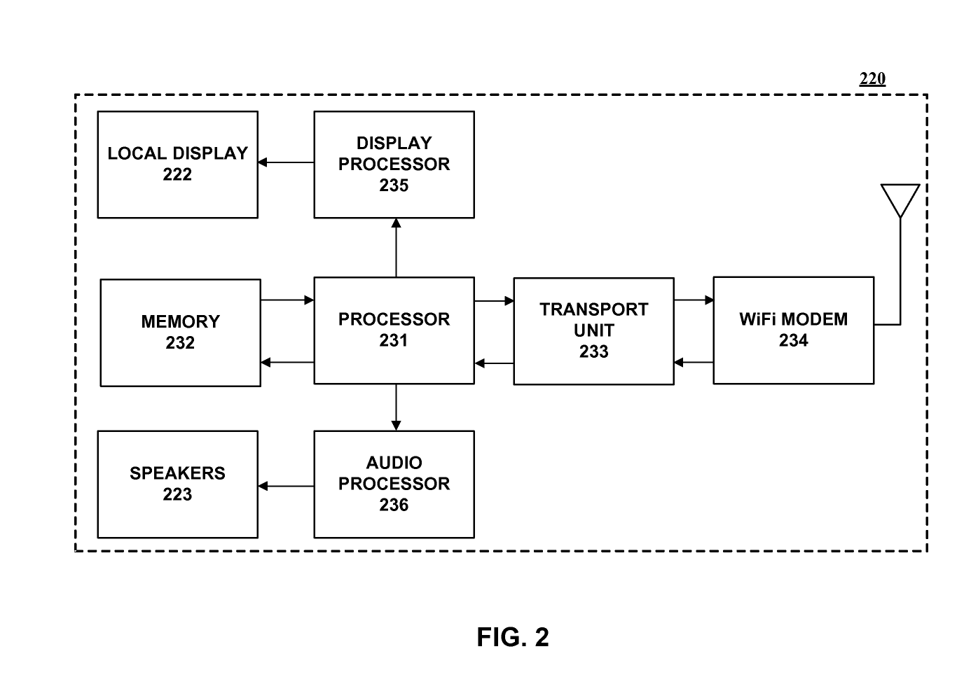

FIG. 2 is a block diagram showing one example of a source device 220. Source device 220 may be a device similar to source device 120 in FIG. 1 and may operate in the same manner as source device 120. Source device 220 includes local display 222, local speaker 223, processors 231, memory 232, transport unit 233, and wireless modem 234. As shown in FIG. 2, source device 220 may include one or more processors (i.e. processor 231) that encode and/or decode A/V data for transport, storage, and display. The A/V data may for example be stored at memory 232. Memory 232 may store an entire A/V file, or may comprise a smaller buffer that simply stores a portion of an A/V file, e.g., streamed from another device or source. Transport unit 233 may process encoded A/V data for network transport. For example, encoded A/V data may be processed by processor 231 and encapsulated by transport unit 233 into Network Access Layer (NAL) units for communication across a network. The NAL units may be sent by wireless modem 234 to a wireless sink device via a network connection. Wireless modem 234 may, for example, be a Wi-Fi modem configured to implement one of the IEEE 802.11 family of standards. Source device 220 may also contain other components for transmitting NAL units that are not pictured, such as a Bluetooth transmitter, an Ethernet transmitter, or a USB transmitter.

Source device 220 may also locally process and display A/V data. In particular display processor 235 may process video data to be displayed on local display 222, audio processor 236 may process audio data for output on speaker 223.

As described above with reference to source device 120 of FIG. 1, source device 220 may also receive user input commands from a sink device. In this manner, wireless modem 234 of source device 220 receives encapsulated data packets, such as NAL units, and sends the encapsulated data units to transport unit 233 for decapsulation. For instance, transport unit 233 may extract data packets from the NAL units, and processor 231 can parse the data packets to extract the user input commands. Based on the user input commands, processor 231 can adjust the encoded A/V data being transmitted by source device 220 to a sink device. In this manner, the functionality described above in reference to A/V control module 125 of FIG. 1 may be implemented, either fully or partially, by processor 231.

Processor 231 of FIG. 2 generally represents any of a wide variety of processors, including but not limited to one or more digital signal processors (DSPs), general purpose microprocessors, application specific integrated circuits (ASICs), field programmable logic arrays (FPGAs), other equivalent integrated or discrete logic circuitry, or some combination thereof. Memory 232 of FIG. 2 may comprise any of a wide variety of volatile or non-volatile memory, including but not limited to random access memory (RAM) such as dynamic random access memory (DRAM), resistive RAM (RRAM), synchronous dynamic random access memory (SDRAM), read-only memory (ROM), non-volatile random access memory (NVRAM), electrically erasable programmable read-only memory (EEPROM), FLASH memory, and the like, Memory 232 may comprise a computer-readable storage medium for storing audio/video data, as well as other kinds of data. Memory 232 may additionally store instructions and program code that are executed by processor 231 as part of performing the various techniques described in this disclosure, such as transmitting media data in a media agnostic manner.

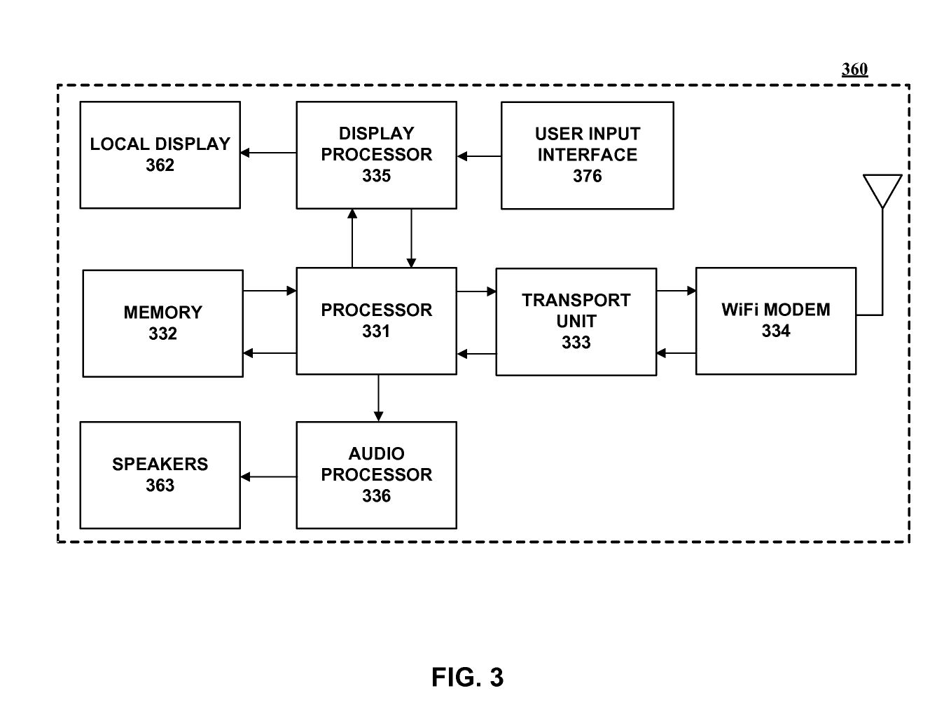

Source device 220 may execute techniques of this disclosure. Memory 232 may store application data used in techniques of this disclosure. Further, processor 231 may be configured to establish a connection to a sink device, such as sink device 360 of FIG. 3. Processor 231 may also perform a service discovery using a real time streaming protocol (RTSP) mechanism. In some examples, the service discovery may provide media agnostic display attributes of the sink device to the source device and a connection type between the source device and the sink device. Processor 231 may further encapsulate application data stored in memory 232 at the source device based at least in part on the connection type and the media agnostic display attributes. Processor 231 may also establish a streaming session between source device 220 and the sink device. Processor 231 may send, in the streaming session, the encapsulated application data to the sink device.

FIG. 3 shows an example of a sink device 360. Sink device 360 may be a device similar to sink device 160 in FIG. 1 and may operate in the same manner as sink device 160. Sink device 360 includes one or more processors (i.e. processor 331), memory 332, transport unit 333, wireless modem 334, display processor 335, local display 362, audio processor 336, speaker 363, and user input interface 376. Sink device 360 receives at wireless modem 334 encapsulated data units sent from a source device. Wireless modem 334 may, for example, be a Wi-Fi modem configured to implement one more standards from the IEEE 802.11 family of standards. Sink device 360 may also contain other components for receiving encapsulated data units that are not pictured, such as a Bluetooth transmitter, an Ethernet transmitter, or a USB transmitter. Transport unit 333 can decapsulate the encapsulated data units. For instance, transport unit 333 may extract encoded video data from the encapsulated data units and send the encoded A/V data to processor 331 to be decoded and rendered for output. Display processor 335 may process decoded video data to be displayed on local display 362, and audio processor 336 may process decoded audio data for output on speaker 363.

In addition to rendering audio and video data, wireless sink device 360 can also receive user input data through user input interface 376. User input interface 376 can represent any of a number of user input devices included but not limited to a touch display interface, a keyboard, a mouse, a voice command module, gesture capture device (e.g., with camera-based input capturing capabilities) or any other of a number of user input devices. User input received through user input interface 376 can be processed by processor 331. This processing may include generating data packets that include the received user input command in accordance with the techniques described in this disclosure. Once generated, transport unit 333 may process the data packets for network transport to a wireless source device over a UIBC.

Processor 331 of FIG. 3 may comprise one or more of a wide range of processors, such as one or more digital signal processors (DSPs), general purpose microprocessors, application specific integrated circuits (ASICs), field programmable logic arrays (FPGAs), other equivalent integrated or discrete logic circuitry, or some combination thereof. Memory 332 of FIG. 3 may comprise any of a wide variety of volatile or non-volatile memory, including but not limited to random access memory (RAM) such as dynamic random access memory (DRAM), resistive RAM (RRAM), synchronous dynamic random access memory (SDRAM), read-only memory (ROM), non-volatile random access memory (NVRAM), electrically erasable programmable read-only memory (EEPROM), FLASH memory, and the like, Memory 232 may comprise a computer-readable storage medium for storing audio/video data, as well as other kinds of data. Memory 332 may additionally store instructions and program code that are executed by processor 331 as part of performing the various techniques described in this disclosure, such as transmitting media data in a media agnostic manner.

Sink device 360 may execute techniques of this disclosure. Memory 332 may store application data used in techniques of this disclosure. Further, processor 331 may be configured to establish a connection to a source device, such as source device 220 of FIG. 2. Processor 331 may also perform a service discovery using a real time streaming protocol (RTSP) mechanism. In some examples, the service discovery may provide media agnostic display attributes of the sink device to the source device and a connection type between the source device and the sink device. Processor 331 may also establish a streaming session between the source device and sink device 360. Processor 331 may receive, in the streaming session, the encapsulated application data to the sink device. The encapsulated application data may be based at least in part on the connection type and the media agnostic display attributes

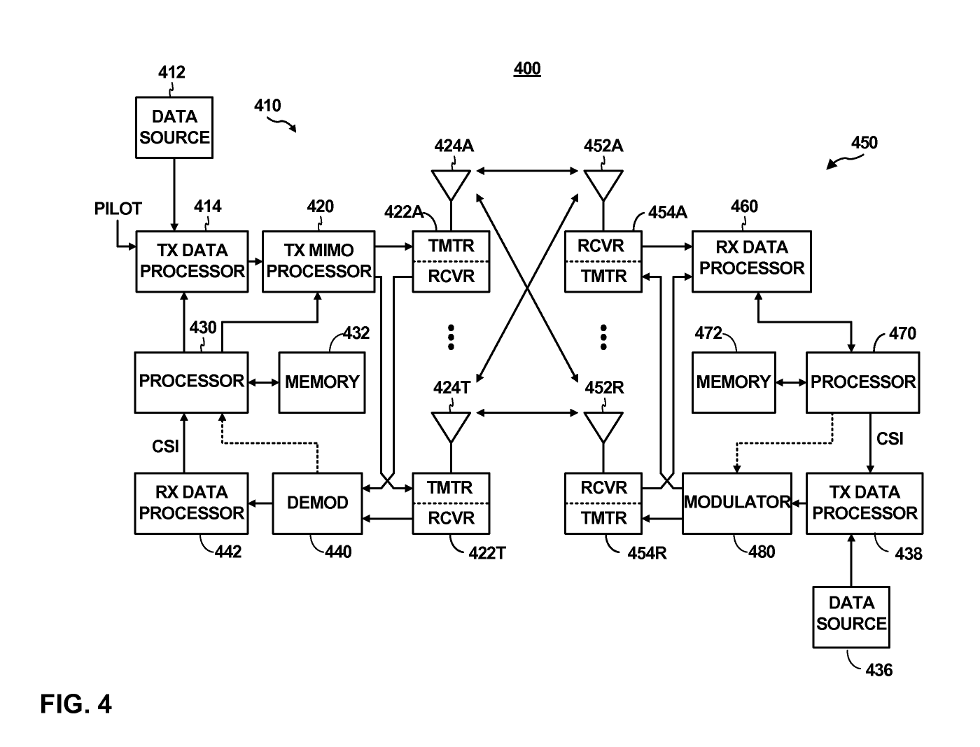

FIG. 4 shows a block diagram of an example transmitter system 410 and receiver system 450, which may be used by transmitter/receiver 132 and transmitter/receiver 162 of FIG. 1 for communicating over communication channel 150. At transmitter system 410, traffic data for a number of data streams is provided from a data source 412 to a transmit (TX) data processor 414. Each data stream may be transmitted over a respective transmit antenna. TX data processor 414 formats, codes, and interleaves the traffic data for each data stream based on a particular coding scheme selected for that data stream.

The coded data for each data stream may be multiplexed with pilot data using orthogonal frequency division multiplexing (OFDM) techniques. A wide variety of other wireless communication techniques may also be used, including but not limited to time division multi access (TDMA), frequency division multi access (FDMA), code division multi access (CDMA), or any combination of OFDM, FDMA, TDMA and/or CDMA.

Consistent with FIG. 4, the pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK, or M-QAM (Quadrature Amplitude Modulation), where M may be a power of two) selected for that data stream to provide modulation symbols. The data rate, coding, and modulation for each data stream may be determined by instructions performed by processor 430 which may be coupled with memory 432.

The modulation symbols for the data streams are then provided to a TX multiple-input and multiple output (MIMO) processor 420, which may further process the modulation symbols (e.g., for OFDM). TX MIMO processor 420 can then provide N_{T} modulation symbol streams to N_{T} transmitters (TMTR) 422a through 422t. In certain aspects, TX MIMO processor 420 applies beamforming weights to the symbols of the data streams and to the antenna from which the symbol is being transmitted.

Each transmitter 422 may receive and process a respective symbol stream to provide one or more analog signals, and further conditions (e.g., amplifies, filters, and upconverts) the analog signals to provide a modulated signal suitable for transmission over the MIMO channel. N_{T} modulated signals from transmitters 422a through 422t are then transmitted from N_{T} antennas 424a through 424t, respectively.

At receiver system 450, the transmitted modulated signals are received by N_{R} antennas 452a through 452r and the received signal from each antenna 452 is provided to a respective receiver (RCVR) 454a through 454r. Receiver 454 conditions (e.g., filters, amplifies, and downconverts) a respective received signal, digitizes the conditioned signal to provide samples, and further processes the samples to provide a corresponding “received” symbol stream.

A receive (RX) data processor 460 then receives and processes the N_{R} received symbol streams from N_{R} receivers 454 based on a particular receiver processing technique to provide N_{T} “detected” symbol streams. The RX data processor 460 then demodulates, deinterleaves and decodes each detected symbol stream to recover the traffic data for the data stream. The processing by RX data processor 460 is complementary to that performed by TX MIMO processor 420 and TX data processor 414 at transmitter system 410.

A processor 470 that may be coupled with a memory 472 periodically determines which pre-coding matrix to use. The reverse link message may comprise various types of information regarding the communication link and/or the received data stream. The reverse link message is then processed by a TX data processor 438, which also receives traffic data for a number of data streams from a data source 436, modulated by a modulator 480, conditioned by transmitters 454a through 454r, and transmitted back to transmitter system 410.

At transmitter system 410, the modulated signals from receiver system 450 are received by antennas 424, conditioned by receivers 422, demodulated by a demodulator 440, and processed by a RX data processor 442 to extract the reserve link message transmitted by the receiver system 450. Processor 430 then determines which pre-coding matrix to use for determining the beamforming weights then processes the extracted message.

In some examples, transmitter system 410 may be implemented in a source device, such as source device 120 of FIG. 1 or source device 220 of FIG. 2. As such, transmitter system 410 may execute techniques of this disclosure. For example, transmitter system 410 may send, in a streaming session, encapsulated application data to a sink device that contains receiver system 450.

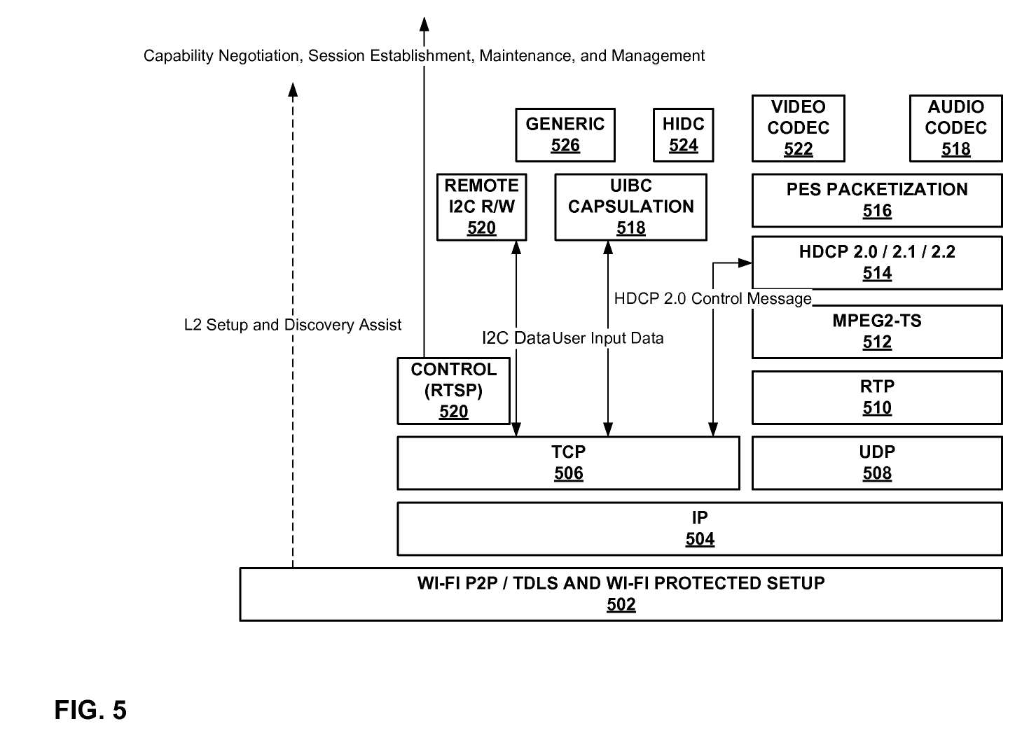

FIG. 5 is block diagram illustrating functional blocks in wireless display data and control planes, according to one or more techniques of this disclosure. In some examples, the source device comprises a data plane and a control plane. The data plane consists of video codec 522 (as described in section 3.4.2 and 3.4.3 of the Wi-Fi Display Technical Specification), audio codec 518 (as described in section 3.4.1 of the Wi-Fi Display Technical Specification), PES packetization 516 (as described in Annex-B of the Wi-Fi Display Technical Specification), the high definition copy protocol (HDCP) system 2.0/2.1/2.2 514 (as described in section 4.7 of the Wi-Fi Display Technical Specification), and MPEG2 transform stream (MPEG2-TS) 512 over RTP 510/UDP 508/IP 504 (as described in section 4.10.2 and Annex-B of the Wi-Fi Display Technical Specification). The control plane consists of RTSP 520 over TCP 506/IP 504 (as described in section 6 of the Wi-Fi Display Technical Specification), remote I2C Read/Write 520 (as described in section 7 of the Wi-Fi Display Technical Specification), UIBC 518 with HIDC 524 and generic user input 526 (as described in section 4.11 of the Wi-Fi Display Technical Specification), and the HDCP session key establishment (as described in section 4.7 of the Wi-Fi Display Technical Specification). The Wi-Fi P2P/TDLS block 502 forms the layer-2 connectivity using either Wi-Fi P2P or TDLS (as described in section 4.5 of the Wi-Fi Display Technical Specification).

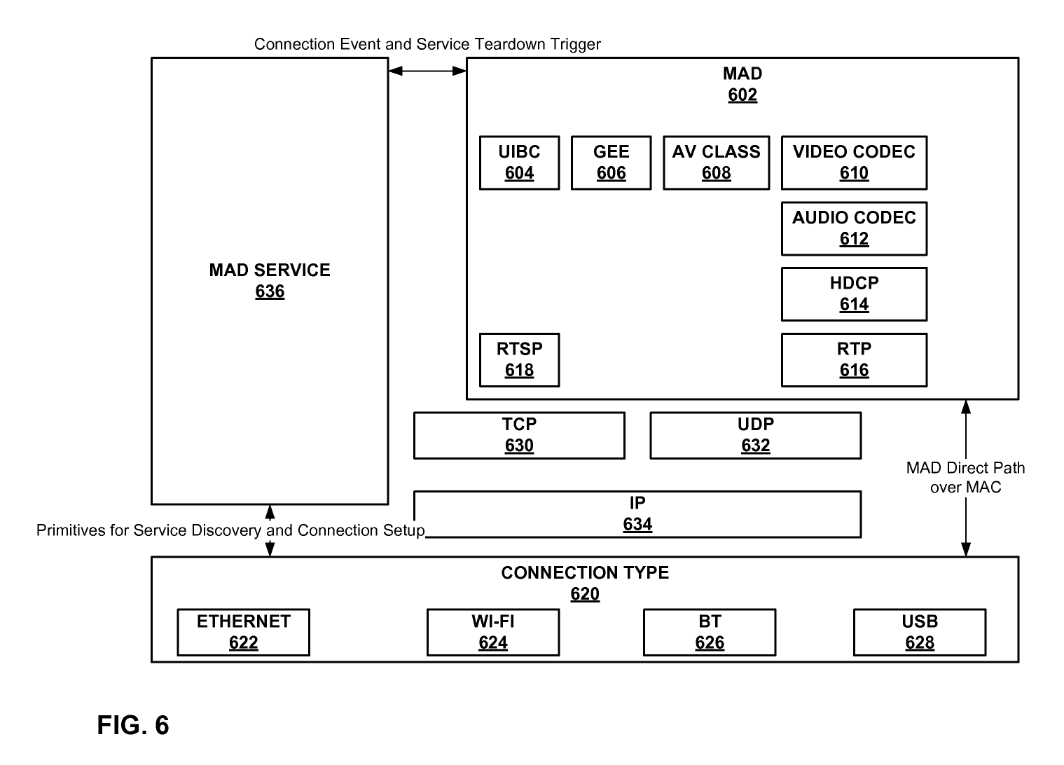

FIG. 6 is a block diagram illustrating a media agnostic display architecture with a media agnostic display service, according to one or more techniques of this disclosure. In this example, media agnostic display 602 contains UIBC 604, graphics entity engine (GEE) 606, audio/visual (AV) Class 608, video codec 610, audio codec 612, HDCP 614, RTP 616, and RTSP 618. In some examples, connection type 620 is any of an Ethernet connection 622, a Wi-Fi connection 624, a Bluetooth (BT) connection 626, or a Universal Serial Bus (USB) connection 628. Media agnostic display 602 may communicate with media agnostic display service 636 for connection events and service teardown triggers. Either media agnostic display 602 or media agnostic display service 636 may communicate with a media access control (MAC) address via any of TCP 630, UDP 632, or IP 634, alone or in combination, using any connection type 620 of Ethernet 622, Wi-Fi 624, BT 626, or USB 628. Media agnostic display service 636 may communicate with a MAC address using primitives for service discovery and search setup. Media agnostic device 602 may communicate with a MAC address using a direct path over the MAC.

According to techniques of this disclosure, the source device may send the encapsulated application data to the sink device via a data path. In the example of FIG. 6, any of the following data path options are possible:
Audio codec 612−>HDCP 614−>RTP 616−>UDP 632−>IP 634−>MAC
Audio codec 612−>HDCP 614−>RTP 616−>TCP 630−>IP 634−>MAC
   Audio codec 612−>HDCP 614−>RTP 616−>LLC/SNAP−>MAC
Video codec 610−>HDCP 614−>RTP 616−>UDP 632−>IP 624−>MAC
Video codec 610−>HDCP 614−>RTP 616−>TCP 630−>IP 624−>MAC
   Video codec 610−>HDCP 614−>RTP 616−>LLC/SNAP−>MAC
AV Class 608−>HDCP 614−>RTP 616−>UDP 632−>IP 624−>MAC
AV Class 608−>HDCP 614−>RTP 616−>TCP 630−>IP 624−>MAC
   AV Class 608−>HDCP 614−>RTP 616−>LLC/SNAP−>MAC
GEE 606−>HDCP 614−>RTP 616−>UDP 632−>IP 624−>MAC
GEE 606−>HDCP 614−>RTP 616−>TCP 630−>IP 624−>MAC
   GEE 606−>HDCP 614−>UDP 632−>IP 624−>MAC
   GEE 606−>HDCP 614−>TCP 630−>IP 624−>MAC
      GEE 606−>TCP 630−>IP 624−>MAC
      GEE 606−>UDP 632−>IP 624−>MAC

In the example of FIG. 6, a possible session control or post-connection discovery option path is RTSP 618−>TCP 630−>IP 624−>MAC.

In the example of FIG. 6, a possible user input control option path is UIBC 604−>TCP 630−>IP 624−>MAC.

In the example of FIG. 6, any of the following pre-connection discovery option paths are possible:
MAD Service 636−>TCP 630−>IP 624−>MAC
MAD Service 636−>UDP 632−>IP 624−>MAC
   MAD Service 636−>LLC/SNAP−>MAC

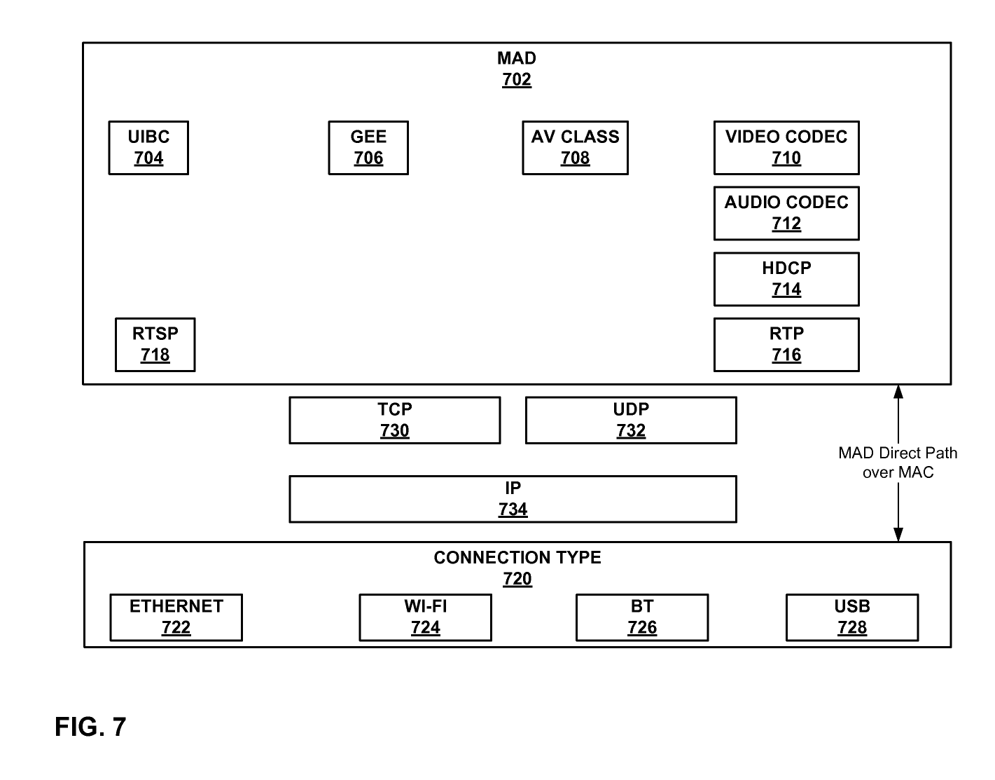

FIG. 7 is a block diagram illustrating a media agnostic display architecture without a media agnostic display service, according to one or more techniques of this disclosure. In this example, media agnostic display 702 contains UIBC 704, graphics entity engine (GEE) 706, audio/visual (AV) Class 708, video codec 710, audio codec 712, HDCP 714, RTP 716, and RTSP 718. Media agnostic display 702 may communicate with a media access control (MAC) address via any of TCP 730, UDP 732, or IP 734, alone or in combination, using any connection type 720 of Ethernet 722, Wi-Fi 724, BT 726, or USB 728. Media agnostic device 702 may communicate with a MAC address using a direct path over the MAC.

According to techniques of this disclosure, the source device may send the encapsulated application data to the sink device via a data path. In the example of FIG. 7, any of the following data path options are possible:
Audio codec 712−>HDCP 714−>RTP 716−>UDP 732−>IP 734−>MAC
Audio codec 712−>HDCP 714−>RTP 716−>TCP 730−>IP 734−>MAC
   Audio codec 712−>HDCP 714−>RTP 716−>LLC/SNAP−>MAC
Video codec 710−>HDCP 714−>RTP 716−>UDP 732−>IP 724−>MAC
Video codec 710−>HDCP 714−>RTP 716−>TCP 730−>IP 724−>MAC
   Video codec 710−>HDCP 714−>RTP 716−>LLC/SNAP−>MAC
AV Class 708−>HDCP 714−>RTP 716−>UDP 732−>IP 724−>MAC
AV Class 708−>HDCP 714−>RTP 716−>TCP 730−>IP 724−>MAC
   AV Class 708−>HDCP 714−>RTP 716−>LLC/SNAP−>MAC
GEE 706−>HDCP 714−>RTP 716−>UDP 732−>IP 724−>MAC
GEE 706−>HDCP 714−>RTP 716−>TCP 730−>IP 724−>MAC
   GEE 706−>HDCP 714−>UDP 732−>IP 724−>MAC
   GEE 706−>HDCP 714−>TCP 730−>IP 724−>MAC
      GEE 706−>TCP 730−>IP 724−>MAC
      GEE 706−>UDP 732−>IP 724−>MAC

In the example of FIG. 7, a possible session control or post-connection discovery option path is RTSP 718−>TCP 730−>IP 724−>MAC.

In the example of FIG. 7, a possible user input control option path is UIBC 704−>TCP 730−>IP 724−>MAC.

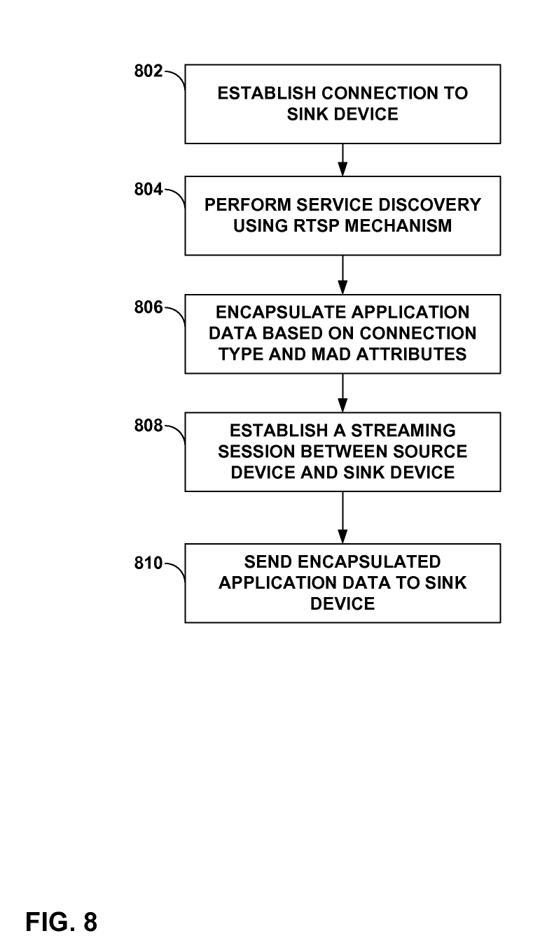

FIG. 8 is a flow diagram illustrating one or more techniques of this disclosure for a media agnostic display architecture on a source device. In techniques of this disclosure, a source device (e.g., source device 120) establishes a connection to a sink device (e.g., sink device 160) (802). In some examples, the source device comprises a data plane and a control plane.

As shown in FIG. 8, the source device performs a service discovery using a real time streaming protocol (RTSP) mechanism (804). In some examples, the service discovery provides media agnostic display attributes of the sink device to the source device and a connection type between the source device and the sink device. In some examples, the connection type is any of an Ethernet connection, a Wi-Fi connection, a Bluetooth connection, or a Universal Serial Bus connection. In some examples, the media agnostic display attributes include one or more of display device information, display audio formats, display video formats, display three-dimensional video formats, content protection, graphics entity engine, and vendor specific information.

The source device encapsulates application data at the source device based at least in part on the connection type (806). The source device establishes a streaming session between the source device and the sink device (808). In some examples, the source device may establish a plurality of streaming sessions. In the streaming session, the source device sends the encapsulated application data to the sink device (810).

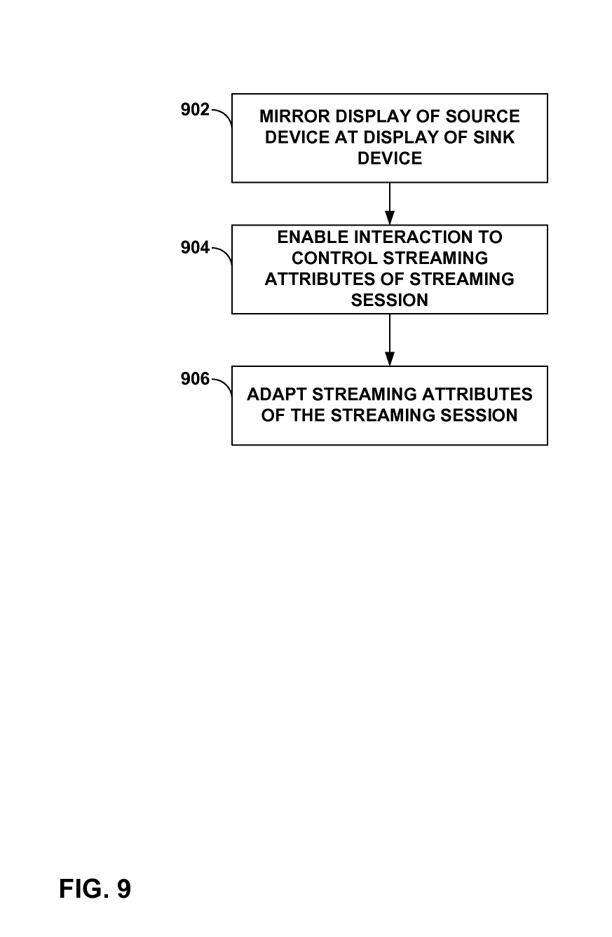

FIG. 9 is a flow diagram illustrating one or more techniques of this disclosure for a media agnostic display architecture with streaming adaptation capabilities. The source device mirrors its display at a display of the sink device based at least in part on the encapsulated application data (902). The source device enables an interaction to control one or more streaming attributes of the streaming session from the source device via a user interface back channel (904). In some examples, the one or more streaming attributes the streaming attributes include one or more a resolution rate, a refresh rate, a codec level, an enabling of a particular data stream, a disabling of a particular data stream, an enabling of a data stream over TCP, a disabling of a data stream over TCP, an enabling of a data stream over UDP, and a disabling of a data stream over UDP. Responsive to the streaming attributes indicating a poor connection, the source device adapts the one or more streaming attributes of the streaming session (906).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. In some examples, computer-readable media may comprise non-transitory computer-readable media. Data storage media may be any available media that can be accessed by one or more computers or one or more processors to retrieve instructions, code and/or data structures for implementation of the techniques described in this disclosure.

By way of example, and not limitation, such computer-readable media can comprise non-transitory media such as RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. These and other examples are within the scope of the following claims.

1. A method of transmitting media data, the method comprising:
establishing, by a source device, a connection to a sink device;
performing, by the source device, a service discovery using a real time streaming protocol (RTSP) mechanism, wherein the service discovery provides media agnostic display attributes of the sink device to the source device and a connection type between the source device and the sink device;
encapsulating, by the source device, application data at the source device based at least in part on the connection type and the media agnostic display attributes;
establishing, by the source device, a streaming session between the source device and the sink device; and
sending, by the source device in the streaming session, the encapsulated application data to the sink device.

2. The method of claim 1, further comprising:
mirroring, at a display of the sink device and based at least in part on the encapsulated application data, a display of the source device;
enabling, via a user interface back channel at the source device, an interaction to control one or more streaming attributes of the streaming session from the source device; and
responsive to the streaming attributes indicating a poor connection, adapting, by the source device, the one or more streaming attributes of the streaming session.

3. The method of claim 2, wherein the one or more streaming attributes include one or more a resolution rate, a refresh rate, a codec level, a codec profile, an enabling of a particular data stream, a disabling of a particular data stream, an enabling of a data stream over TCP, a disabling of a data stream over TCP, an enabling of a data stream over UDP, and a disabling of a data stream over UDP.

4. The method of claim 1, wherein the source device establishes a plurality of streaming sessions.

5. The method of claim 1, wherein the connection type is any of an Ethernet connection, a Wi-Fi connection, a Bluetooth connection, or a Universal Serial Bus connection.

6. The method of claim 1, wherein the source device comprises a data plane and a control plane.

7. The method of claim 1, wherein the media agnostic display attributes include one or more of display device information, display audio formats, display video formats, display three-dimensional video formats, content protection, graphics entity engine, and vendor specific information.

8. A device for transmitting media data, the device comprising:
a memory storing application data; and
one or more processors configured to:
establish a connection to a sink device;
perform a service discovery using a real time streaming protocol (RTSP) mechanism, wherein the service discovery provides media agnostic display attributes of the sink device to the source device and a connection type between the source device and the sink device;
encapsulate the application data at the source device based at least in part on the connection type and the media agnostic display attributes;
establish a streaming session between the source device and the sink device; and
send, in the streaming session, the encapsulated application data to the sink device.

9. The device of claim 8, wherein the one or more processors are further configured to:
mirror, at a display of the sink device and based at least in part on the encapsulated application data, a display of the source device;
enable, via a user interface back channel, an interaction to control one or more streaming attributes of the streaming session from the source device; and
responsive to the streaming attributes indicating a poor connection, adapt the one or more streaming attributes of the streaming session.

10. The device of claim 9, wherein the one or more streaming attributes include one or more a resolution rate, a refresh rate, a codec level, a codec profile, an enabling of a particular data stream, a disabling of a particular data stream, an enabling of a data stream over TCP, a disabling of a data stream over TCP, an enabling of a data stream over UDP, and a disabling of a data stream over UDP.

11. The device of claim 8, wherein the one or more processors are further configured to establish a plurality of streaming sessions.

12. The device of claim 8, wherein the connection type is any of an Ethernet connection, a Wi-Fi connection, a Bluetooth connection, or a Universal Serial Bus connection.

13. The device of claim 8, wherein the device further comprises a data plane and a control plane.

14. The device of claim 8, wherein the media agnostic display attributes include one or more of display device information, display audio formats, display video formats, display three-dimensional video formats, content protection, graphics entity engine, and vendor specific information.

15. A computer-readable medium comprising instructions stored thereon that when executed in a processor of a source device to:
establish a connection to a sink device;
perform a service discovery using a real time streaming protocol (RTSP) mechanism, wherein the service discovery provides media agnostic display attributes of the sink device to the source device and a connection type between the source device and the sink device;
encapsulate application data at the source device based at least in part on the connection type and the media agnostic display attributes;
establish a streaming session between the source device and the sink device; and
send, in the streaming session, the encapsulated application data to the sink device.

16. The computer-readable storage medium of claim 15, wherein the instructions further cause the source device to:
mirror, at a display of the sink device and based at least in part on the encapsulated application data, a display of the source device;
enable, via a user interface back channel at the source device, an interaction to control one or more streaming attributes of the streaming session from the source device; and
responsive to the streaming attributes indicating a poor connection, adapt the one or more streaming attributes of the streaming session.

17. The computer-readable storage medium of claim 16, wherein the one or more streaming attributes include one or more a resolution rate, a refresh rate, a codec level, a codec profile, an enabling of a particular data stream, a disabling of a particular data stream, an enabling of a data stream over TCP, a disabling of a data stream over TCP, an enabling of a data stream over UDP, and a disabling of a data stream over UDP.

18. The computer-readable storage medium of claim 15, wherein the source device establishes a plurality of streaming sessions.

19. The computer-readable storage medium of claim 15, wherein the connection type is any of an Ethernet connection, a Wi-Fi connection, a Bluetooth connection, or a Universal Serial Bus connection.

20. The computer-readable storage medium of claim 15, wherein the source device comprises a data plane and a control plane.

21. The computer-readable storage medium of claim 15, wherein the media agnostic display attributes include one or more of display device information, display audio formats, display video formats, display three-dimensional video formats, content protection, graphics entity engine, and vendor specific information.

22. An apparatus for transmitting media data, the apparatus comprising:
means for establishing a connection to a sink device;
means for performing a service discovery using a real time streaming protocol (RTSP) mechanism, wherein the service discovery provides media agnostic display attributes of the sink device to the source device and a connection type between the source device and the sink device;
means for encapsulating application data at the source device based at least in part on the connection type and the media agnostic display attributes;
means for establishing a streaming session between the source device and the sink device; and
means for sending, in the streaming session, the encapsulated application data to the sink device.

23. The apparatus of claim 22, further comprising:
means for mirroring, at a display of the sink device and based at least in part on the encapsulated application data, a display of the source device;
means for enabling, via a user interface back channel, an interaction to control one or more streaming attributes of the streaming session from the source device; and
means for adapting the one or more streaming attributes of the streaming session responsive to the streaming attributes indicating a poor connection.

24. The apparatus of claim 23, wherein the one or more streaming attributes include one or more a resolution rate, a refresh rate, a codec level, a codec profile, an enabling of a particular data stream, a disabling of a particular data stream, an enabling of a data stream over TCP, a disabling of a data stream over TCP, an enabling of a data stream over UDP, and a disabling of a data stream over UDP.

25. The apparatus of claim 22, wherein the means for establishing a streaming session comprises means for establishing a plurality of streaming sessions.

26. The apparatus of claim 22, wherein the connection type is any of an Ethernet connection, a Wi-Fi connection, a Bluetooth connection, or a Universal Serial Bus connection.

27. The apparatus of claim 22, wherein the apparatus comprises a data plane and a control plane.

28. The apparatus of claim 22, wherein the media agnostic display attributes include one or more of display device information, display audio formats, display video formats, display three-dimensional video formats, content protection, graphics entity engine, and vendor specific information.
